(19) United States
(12) Patent Application Publication
(10) Pub. No.: US 2016/0057163 A1
(43) Pub. Date: Feb. 25, 2016

(54) VALIDATING AND ENFORCING END-USER WORKFLOW FOR A WEB APPLICATION

(71) Applicant: Akamai Technologies, Inc., Cambridge, MA (US)

(72) Inventors: Patrice Boffa, Mountain View, CA (US); Eugene Y. Zhang, San Jose, CA (US)

(73) Assignee: AKAMAI TECHNOLOGIES, INC., Cambridge, MA (US)

(21) Appl. No.: 14/868,472

(22) Filed: Sep. 29, 2015

Related U.S. Application Data
(60) Provisional application No. 62/059,785, filed on Oct. 3, 2014.

(51) Int. Cl. H04L 29/06

(52) U.S. Cl. CPC H04L 63/1425; H04L 63/123

(57) ABSTRACT

Described herein, without limitation, are methods and systems to defend web applications against abuse and attack from bots, scrapers, and agents, by validating and enforcing a workflow for web application users. Described herein, without limitation, are methods and systems that enforce and validate workflows in a way that enables web application owners to flexibly define and control workflows, even for complex website topologies.

This application is based on and claims the benefit of priority of U.S. Application No. 62/059,785, filed Oct. 3, 2014, the contents of which are hereby incorporated by reference in their entirety.

This patent document contains material which is subject to copyright protection. The copyright owner has no objection to the facsimile reproduction by anyone of the patent document or the patent disclosure, as it appears in Patent and Trademark Office patent files or records, but otherwise reserves all copyright rights whatsoever.

### BACKGROUND

1. Technical Field

This application relates generally to distributed data processing systems and to the delivery of content to users over computer networks, and to web application security.

2. Brief Description of the Related Art

Modern web applications frequently implement complex control flows, which require the users to perform actions in a given order. Users typically interact with a web application by sending HTTP requests with parameters and in response receive web pages with hyperlinks that indicate the expected next actions. One example of workflow control system is breadcrumb navigation control. It shows users which step they are on, which steps they've completed, and which steps they have yet to complete. It allows them to navigate to next step and previous steps, but does not allow them to click on future steps to skip ahead.

Unfortunately, web applications are often abused or outright attacked by bots, scrapers, and agents. For example, e-commerce sites attract price scrapers, which gather information and gives competitors easy access to product listings, SKUs and pricing. Price scraping activity can also be used to artificially inflate price through reservation system pricing algorithms, harming the business of the e-commerce site.

Some sites require a user login. Typically, to login to their account, a user first requests the login page, enter their credentials, and then submits the form (e.g., via an HTTP POST) to an authentication URL. However, malicious actors use stolen usernames and passwords to simulate a user login by performing direct POST requests to authentication URL without requesting the login page contains form inputs. Moreover, if stolen usernames and passwords are unavailable, these actors will submit many requests with different usernames and/or passwords in an attempt to guess the correct ones. This brute force method is sometimes referred to as a dictionary attack.

Sites that provide tickets and/or reservations are also the target of abuse. Botnets are employed against entertainment event-ticketing sites, for example, to buy concert seats. These seats are often merely bought by ticket brokers, who resell the tickets at an inflated price. They employ scripted bots to automate the purchasing/reservation process. The bot runs through the purchase process and obtains seats by grabbing as many seats as it can within a very short period of time. A bot client can complete high-speed transactions in fractions of a second and out-compete human clients. In this way, ticket brokers are able to unfairly obtain seats for themselves while depriving the general public from having a chance to obtain seats (or at least the more desired seats).

It is an object of the teachings hereof to provide methods and system to address these and similar abuses by validating and enforcing a workflow on web application users. It is a further object to enforce and validate workflows in a way that enables web application owners to flexibly define and control workflows, even for complex website topologies. It is a further object to makes attempts for web request forgery difficult and uneconomical for botnet or other automated agent operators.

More specifically in the context in the abuses outlined above, it is an object of the hereof to provide mechanisms to address price scraping and similar practices by validating and enforcing workflows, denying clients that bypass certain steps in an e-shopping process and direct requests (e.g., HTTP POSTs) directly to price query endpoints. It is an object of the teachings hereof to address login attacks by mandating certain authentication steps and preventing client/bot from bypassing mandatory login steps to access authentication API directly. It is an object of the teachings hereof to address ticket/reservation abuses by validating and enforcing workflows, and detecting and blocking rapid firing bot requests.

The teachings herein address these objects and also provide other benefits and improvements that will become apparent in view of this disclosure.

### BRIEF DESCRIPTION OF THE DRAWINGS

The invention will be more fully understood from the following detailed description taken in conjunction with the accompanying drawings, in which:

FIG. 1 is a schematic diagram illustrating one embodiment of a known distributed computer system configured as a content delivery network;

FIG. 2 is a schematic diagram illustrating one embodiment of a machine on which a content delivery server in the system of FIG. 1 can be implemented;

FIG. 3 illustrates a general architecture for a WAN optimized, acceleration and transport service;

FIG. 4 is a block diagram illustrating hardware in a computer system that may be used to implement the teachings hereof;

FIG. 5 is a schematic diagram illustrating a functional flow of a web application workflow validation and enforcement system, in one embodiment;

FIG. 6 is a schematic diagram illustrating a high level system diagram for a web application workflow validation and enforcement system, in one embodiment.

FIG. 7 is a schematic diagram presents a validation process flow for the system show in FIGS. 5-6, in one embodiment;

FIG. 8 is a schematic diagram presents another validation process flow for the system show in FIGS. 5-6, in another embodiment.

### DETAILED DESCRIPTION

The following description sets forth embodiments of the invention to provide an overall understanding of the principles of the structure, function, manufacture, and use of the methods and apparatus disclosed herein. The systems, methods and apparatus described herein and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, publications and references cited herein are expressly incorporated herein by reference in their entirety. Throughout this disclosure, the term “e.g.” is used as an abbreviation for the non-limiting phrase “for example.”

### Introduction

Typically, bots and other automated agents are after specific information and do not follow the typical web flow from a normal user. The systems and methods described herein are designed to provide protection for a predefined workflow, as defined or configured by the web application provider. They enable the provider to configure highly complex flows, including without limitation flows that have one to N or many to many permissible paths amongst pages/steps in the workflow. The web delivery systems then enforces the integrity of these workflows, validating that a given client follows only permitted navigation through the workflow and alerting or blocking impermissible navigation.

In some embodiments, the systems and methods herein utilize a set of transparent challenges (e.g., cookie support, client JavaScript execution, etc.) to provide pinpoint identification of the client (human or bot, “good” or “bad”).

Outlined below are preferable, non-limiting features and capabilities of the solutions described herein:
Provide mechanism to enforce client to execute designed/required web page flow by stepping through mandatory pages/steps.
Flexible way to define many-to-many source/destination associations.
Flexible control of define entry and exit pages of the workflow.
Use a combination of client and server computation methods to identify bot signature.
Provide page-level protection to pages inside the flow with single authentication at entry page.
Validate nominal “think time” (delays between requests) to estimate click speed in filling out the web form by the clients.
Implementation of time-based secure fingerprint to prevent referrer spoofing or URL deep linking
Inline JavaScript/Cookie injection helps identify and deny bot traffic that doesn't have advanced browser capabilities, such as persistent cookie store or client side JavaScript execution
Client/Device agnostic, this solution can be deployed with no client side custom logic

The teachings hereof may be implemented in individual web servers, web platforms or infrastructures, and/or in a distributed web delivery systems such as a content delivery network (CDN). Familiarity with known CDN architectures, systems, and subsystems is assumed; a section on CDNs at the end of the disclosure provides additional detail. The teachings hereof are not limited to CDNs but in some instances below the novel methods and systems disclosed herein are described in the context of a CDN for illustrative purposes only.

High-Level Design Embodiment

Function 1: Workflow definition (by web application provider aka content provider via user configuration interface)
a. Provide list of URLs needs to be protected inside a workflow
b. Define Source-destination page mapping policy in the form of a collection of key-value pairs, e.g., for each (destination) page, a set of one or more permissible source pages.
c. Execute Function 2-4 if requested URL is part of the pre-defined workflow Function 2: Client request validation at edge server
a. If entry page, set secure navigation cookie (function 3).
b. Subsequent pages
   1. Verify page referrer (URL Referer header) is present and from a valid source defined per Function 1 per requested URL
   ii. Verify navigation session cookie is present. If present:
      1. Verify the request was within valid time period, before expiry time and meets minimal “think” time that a human user would exhibit but a bot would not.
      2. Based on the incoming request, construct one way HMAC hash and compare the output with incoming token HMAC value to verify the authenticity of the token in the cookie
   iii. Set new navigation cookie to be checked at next page (function 3).

Function 3: Secure navigation cookie management at edge server
a. Construct new navigation cookie value by using incoming request payload (e.g., current page URL, current time of visit so that “think” time can be validated on next page, etc.
b. Method 1: Reset navSession cookie downstream via set-cookie
c. Method 2: Inject JavaScript into the page response body. The client browser will execute the javascript and set navSession cookie on their local machine when the browser renders the page.

Function 4: Web Application Firewall Action at edge server
a. Set variable to trigger predefined custom rule
b. Perform fail action if needed (e.g. forward a request to a custom failover page or a custom Honey Pot farm
c. A suitable firewall is described in U.S. Pat. No. 8,458,769, the teachings of which are hereby incorporated by reference.

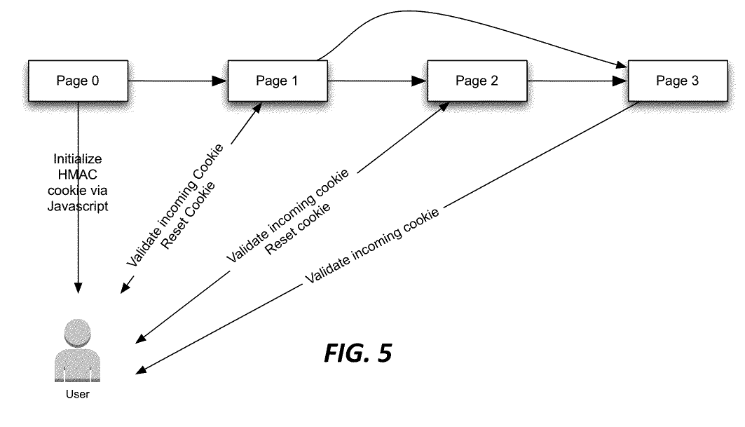

A functional flow diagram is presented in FIG. 5.

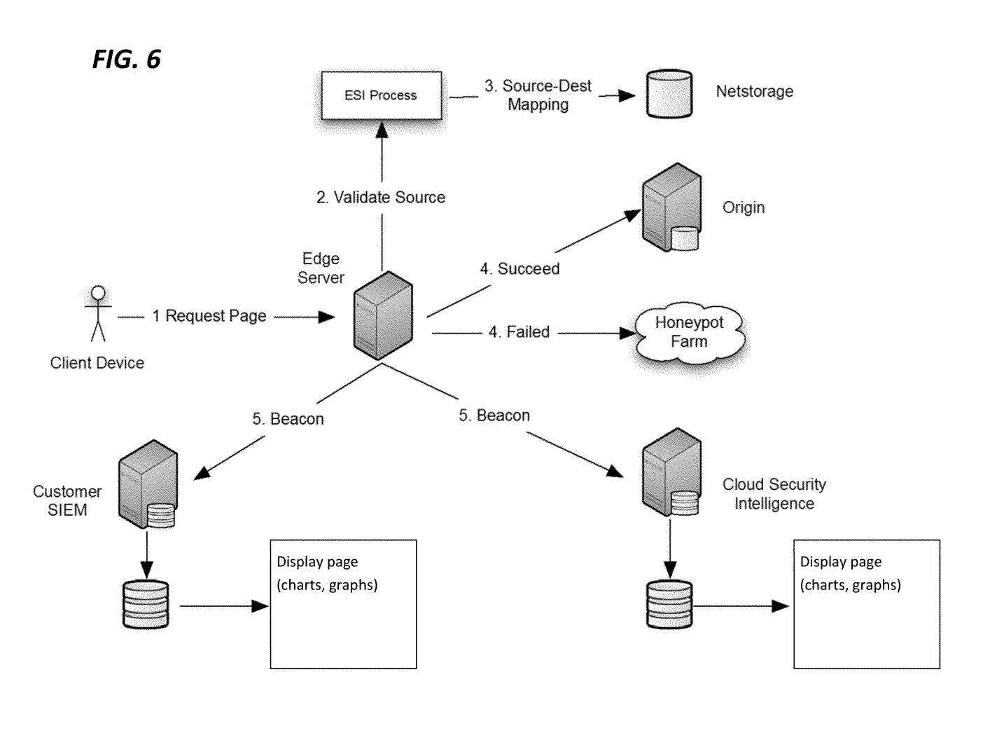

A high level system diagram is shown in FIG. 6. In the diagram below, an ESI process refers to an architecture that specifies how various presentation, data and code components that comprise a Web application or service can be deployed, invalidated, cached, and managed at an edge server as described in U.S. Pat. No. 7,734,823, the teachings of which are incorporated by reference. However, any suitable process or routine or component at the server may be used to perform the role performed by ESI below. The NetStorage label refers a networked storage solution.

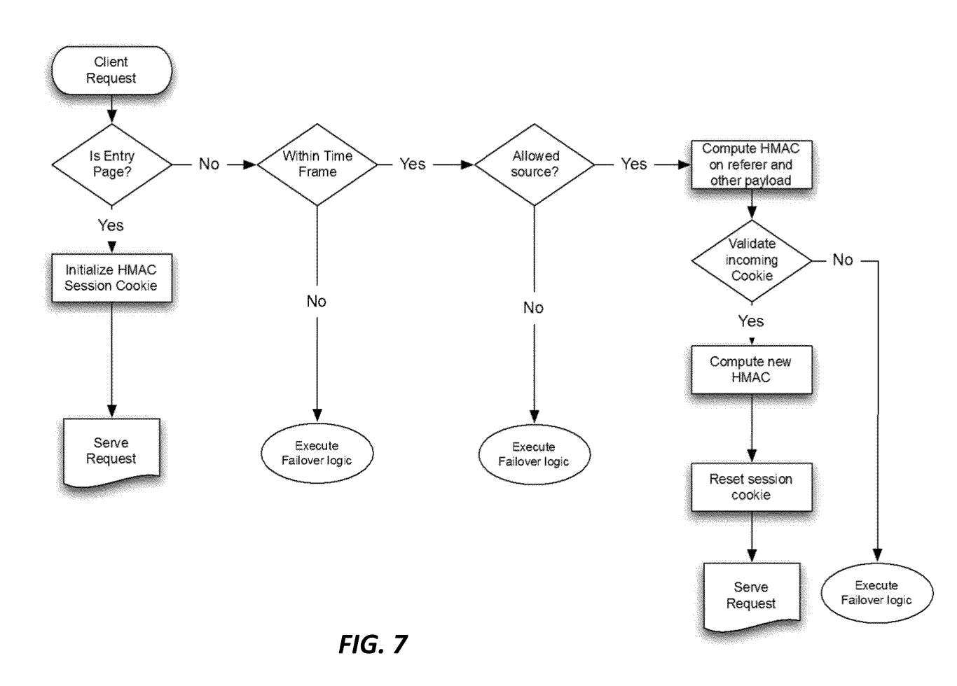

FIG. 7 presents a validation process flow, in the embodiment where the server sets the cookie with the navigation token.

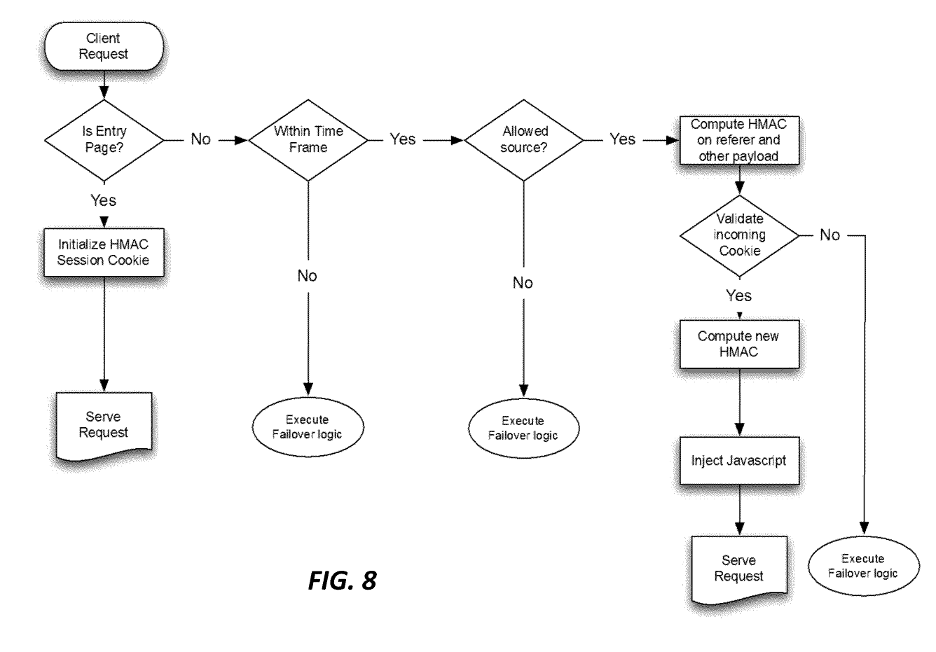

FIG. 8 presents a validation process flow, in the embodiment where the server injects JavaScript into a responsive page being delivered to the client, to cause the client to set the cookie with the navigation token:

Each of the functions is now described in more detail:

Function 1: Workflow definition. A user sets up the system by defining a workflow, which can include multiple permissible destination pages, given a source page. The list of permissible destinations can be stored in a variety ways; two examples are given below using a metadata solution and an ESI solution. However, any data structure at the server could be leveraged to store the mappings and be consulted on client requests to assure permissible flow.
Define navigation (“navSession”) secure token Cookie TTL
Define a listed of protected URLs
If request URL matches with one of the defined entry or other source URLs
   Set BM_WF_STATUS value to set-cookie//this causes the server to set the cookie whenever the client has requested a source page
For each of the page inside the work flow
   Define one or more valid source pages using method 1 or method 2 below or otherwise (metadata or remote ESI file, or other file/data structure)
   Method 1—Metadata indicating permitted page relationships

```
<assign:variable>
    <name>WORKFLOW_POLICY</name>
<value>#/html/page1.html=/html/page0.html#/html/page2.html=/html/page1.html
#/html/page3.html=/html/page1.html~/html/page2.html </value>
</assign:variable>
        ∘ Method 2 — ESI indicating permitted page relationships
<esi:choose>
  <esi:when test=“$(REQUEST_PATH) == ‘/html/page1.html’”>
    <esi:assign name=“VALID_SOURCE” value=“/html/page0.html’” />
  </esi:when>
  <esi:when test=“$(REQUEST_PATH) == ‘/html/page2.html’”>
    <esi:assign name=“VALID_SOURCE” value=“‘/html/page1.html’ ” />
  </esi:when>
    <esi:when test=“$(REQUEST_PATH) == ‘/html/page3.html’”>
    <esi:assign name=“VALID_SOURCE” value=“‘/html/page1.html’, ‘/html/page2.html’”/>
  </esi:when>
</esi:choose>
```

Function 2: Client Request Validation at server upon receiving client request for given page subject in workflow
1 Extract URL referer header and assign to variable BM_WF_REFERER_PATH
   a. If referer URL is valid AND is part of the valid source URL
      i. Allow to Proceed
   b. Else
      i. Assign BM_WF_STATUS to invalid and trigger web application firewall (WAF) rule to alert on or block client request
2 If request is part of the target page and navSession cookie is missing
   i. Assign BM_WF_STATUS to “Missing\navSession\cookie” and trigger WAF rule
3 If navSession cookie is present
   a. Extract HMAC value and expiration time from navSession cookie
      i. Assign HMAC value to BM_WF_NAV_COOKIE_MAC
   b. If expiration time is greater than current time
      i. Assign BM_WF_STATUS to invalid and trigger WAF rule
   c. If expiration time is less than current time
      i. If (current time−(expiration time−time delta))>minimum think time//the system enforces a minimum think time that humans would exhibit, e.g., a couple seconds or more
         1. Assign BM_WF_STATUS to invalid and trigger WAF rule
      ii. Else
         1. Compute hash based on certain elements “CV” of incoming request payload and/or other information available to and/or generated by server
         2. if (BM_WF_NAV_COOKIE_MAC==BM_WF_NAV_COOKIE_MAC_CALC)
            a. Allow to proceed
         3. Else
            a. Assign BM_WF_STATUS to “Invalid\navSession\cookie” and trigger WAF rule

Function 3a
If BM_WF_STATUS value is “valid”
   a. Compute the new expiration time of the cookie (%(NEW_PAGE_EXPIRE_TIME))
   b. Compute hash of certain values “CV” available to and/or generated by server
   c. Setting client cookie navSession=hmac=%(PAGE HMAC)#time=%(PAGE EXPIRE TIME)

Function 3b

If BM_WF_STATUS does not match “valid”
a. Compute the new expiration time of the cookie (%(NEW_PAGE_EXPIRE_TIME))
b. Compute hash of certain values “CV” available to and/or generated by server
c. Modify outgoing response body by injecting the following JavaScript

```
  function setCookie(cookie_value){
      var tExpDate=new Date( );
      var pMinutes = [integer];
      var domain = document.domain;
tExpDate.setTime(tExpDate.getTime( )+(pMinutes*60* 1000) );
      var c_value=escape([%(hash of CV)]) + ((pMinutes==null) ?
“ ”: “; expires=”+ tExpDate.toGMTString( )) + “; path=/” + “;domain=.”+
domain;
      document.cookie= “navSession” + “=” + c_value;
      reload_page( );
    }
```

Function 4—Web application firewall running within or as an adjunct to the server:
Create WAF policy and associate it with the delivery hostname
Create the following customer rule

```
  <security:firewall.action>
    <id>BM_WF_CONTROL</id>
    <tag>AKAMAI/BOT/WF_CONTROL</tag>
    <msg>The webflow control detected an attempt bypass pre-defined
steps</msg>
    <data>%(BM_WF_STATUS)</data>
    <action>%(Rxxxxxxx_ACTION)</action>
    <http-status>403</http-status>
  </security:firewall.action>
```

If BM_WF_STATUS=invalid, trigger the custom rule
Send beacons to customer SIEM and reporting engine
Implement fail action logic to custom response or honeypot if a suspicious activity is detected

### Content Delivery Networks

Distributed computer systems are known in the art. One such distributed computer system is a “content delivery network” or “CDN” that is operated and managed by a service provider, and the teachings of this disclosure may be implemented within a CDN. The service provider typically provides the content delivery service on behalf of third parties. A “distributed system” of this type typically refers to a collection of autonomous computers linked by a network or networks, together with the software, systems, protocols and techniques designed to facilitate various services, such as content delivery or the support of outsourced site infrastructure. This infrastructure is shared by multiple tenants, the content providers. The infrastructure is generally used for the storage, caching, or transmission of content—such as web pages, streaming media and applications—on behalf of such content providers or other tenants. The platform may also provide ancillary technologies used therewith including, without limitation, DNS query handling, provisioning, data monitoring and reporting, content targeting, personalization, and business intelligence.

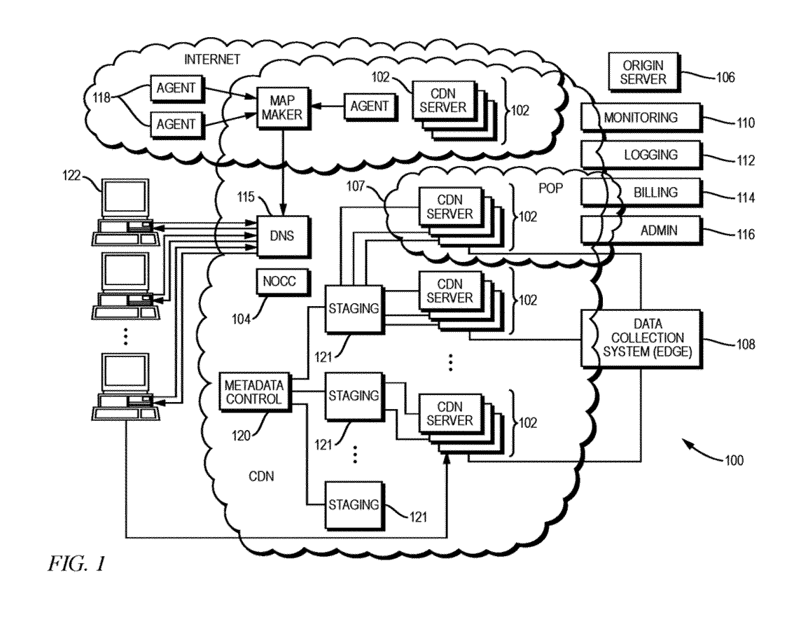

In a known system such as that shown in FIG. 1, a distributed computer system 100 is configured as a content delivery network (CDN) and has a set of servers 102 distributed around the Internet. Typically, most of the servers are located near the edge of the Internet, i.e., at or adjacent end user access networks. A network operations command center (NOCC) 104 may be used to administer and manage operations of the various machines in the system. Third party sites affiliated with content providers, such as web site 106, offload delivery of content (e.g., HTML or other markup language files, embedded page objects, streaming media, software downloads, and the like) to the distributed computer system 100 and, in particular, to the CDN servers (which are sometimes referred to as content servers, or sometimes as “edge” servers in light of the possibility that they are near an “edge” of the Internet). Such servers may be grouped together into a point of presence (POP) 107 at a particular geographic location.

The CDN servers are typically located at nodes that are publicly-routable on the Internet, in end-user access networks, peering points, within or adjacent nodes that are located in mobile networks, in or adjacent enterprise-based private networks, or in any combination thereof

Typically, content providers offload their content delivery by aliasing (e.g., by a DNS CNAME) given content provider domains or sub-domains to domains that are managed by the service provider's authoritative domain name service. The server provider's domain name service directs end user client machines 122 that desire content to the distributed computer system (or more particularly, to one of the CDN servers in the platform) to obtain the content more reliably and efficiently. The CDN servers respond to the client requests, for example by fetching requested content from a local cache, from another CDN server, from the origin server 106 associated with the content provider, or other source, and sending it to the requesting client.

For cacheable content, CDN servers typically employ on a caching model that relies on setting a time-to-live (TTL) for each cacheable object. After it is fetched, the object may be stored locally at a given CDN server until the TTL expires, at which time is typically re-validated or refreshed from the origin server 106. For non-cacheable objects (sometimes referred to as ‘dynamic’ content), the CDN server typically returns to the origin server 106 time when the object is requested by a client. The CDN may operate a server cache hierarchy to provide intermediate caching of customer content in various CDN servers that are between the CDN server handling a client request and the origin server 106; one such cache hierarchy subsystem is described in U.S. Pat. No. 7,376,716, the disclosure of which is incorporated herein by reference.

Although not shown in detail in FIG. 1, the distributed computer system may also include other infrastructure, such as a distributed data collection system 108 that collects usage and other data from the CDN servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115. A distributed data transport mechanism 120 may be used to distribute control information (e.g., metadata to manage content, to facilitate load balancing, and the like) to the CDN servers. The CDN may include a network storage subsystem (sometimes referred to herein as “NetStorage”) which may be located in a network datacenter accessible to the CDN servers and which may act as a source of content, such as described in U.S. Pat. No. 7,472,178, the disclosure of which is incorporated herein by reference.

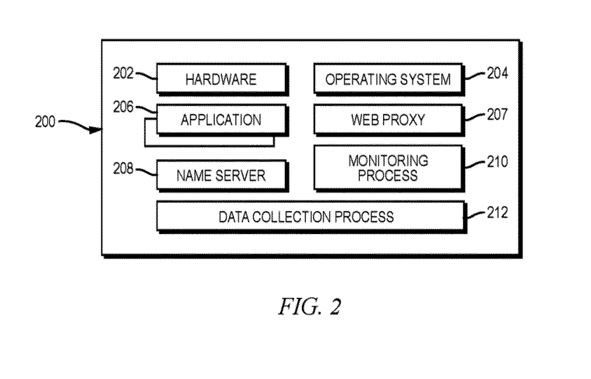

As illustrated in FIG. 2, a given machine 200 in the CDN comprises commodity hardware (e.g., a microprocessor) 202 running an operating system kernel (such as Linux® or variant) 204 that supports one or more applications 206a-n. To facilitate content delivery services, for example, given machines typically run a set of applications, such as an HTTP proxy 207, a name service 208, a local monitoring process 210, a distributed data collection process 212, and the like. The HTTP proxy 207 (sometimes referred to herein as a global host or “ghost”) typically includes a manager process for managing a cache and delivery of content from the machine. For streaming media, the machine may include one or more media servers, such as a Windows® Media Server (WMS) or Flash server, as required by the supported media formats.

A given CDN server shown in FIG. 1 may be configured to provide one or more extended content delivery features, preferably on a domain-specific, content-provider -specific basis, preferably using configuration files that are distributed to the CDN servers using a configuration system. A given configuration file preferably is XML-based and includes a set of content handling rules and directives that facilitate one or more advanced content handling features. The configuration file may be delivered to the CDN server via the data transport mechanism. U.S. Pat. Nos. 7,240,100, the contents of which are hereby incorporated by reference, describe a useful infrastructure for delivering and managing CDN server content control information and this and other control information (sometimes referred to as “metadata”) can be provisioned by the CDN service provider itself, or (via an extranet or the like) the content provider customer who operates the origin server. U.S. Pat. Nos. 7,111,057, incorporated herein by reference, describes an architecture for purging content from the CDN. More information about a CDN platform can be found in U.S. Pat. Nos. 6,108,703 and 7,596,619, the teachings of which are hereby incorporated by reference in their entirety.

In a typical operation, a content provider identifies a content provider domain or sub-domain that it desires to have served by the CDN. When a DNS query to the content provider domain or sub-domain is received at the content provider's domain name servers, those servers respond by returning the CDN hostname (e.g., via a canonical name, or CNAME, or other aliasing technique). That network hostname points to the CDN, and that hostname is then resolved through the CDN name service. To that end, the CDN name service returns one or more IP addresses. The requesting client application (e.g., browser) then makes a content request (e.g., via HTTP or HTTPS) to a CDN server machine associated with the IP address. The request includes a host header that includes the original content provider domain or sub-domain. Upon receipt of the request with the host header, the CDN server checks its configuration file to determine whether the content domain or sub-domain requested is actually being handled by the CDN. If so, the CDN server applies its content handling rules and directives for that domain or sub-domain as specified in the configuration. These content handling rules and directives may be located within an XML-based “metadata” configuration file, as mentioned previously.

The CDN platform may be considered an overlay across the Internet on which communication efficiency can be improved. Improved communications on the overlay can help when a CDN server needs to obtain content from a origin server 106, or otherwise when accelerating non-cacheable content for a content provider customer. Communications between CDN servers and/or across the overlay may be enhanced or improved using improved route selection, protocol optimizations including TCP enhancements, persistent connection reuse and pooling, content & header compression and de-duplication, and other techniques such as those described in U.S. Pat. Nos. 6,820,133, 7,274,658, 7,607,062, and 7,660,296, among others, the disclosures of which are incorporated herein by reference.

As an overlay offering communication enhancements and acceleration, the CDN server resources may be used to facilitate wide area network (WAN) acceleration services between enterprise data centers and/or between branch-headquarter offices (which may be privately managed), as well as to/from third party software-as-a-service (SaaS) providers used by the enterprise users.

In this vein CDN customers may subscribe to a “behind the firewall” managed service product to accelerate Intranet web applications that are hosted behind the customer's enterprise firewall, as well as to accelerate web applications that bridge between their users behind the firewall to an application hosted in the internet cloud (e.g., from a SaaS provider).

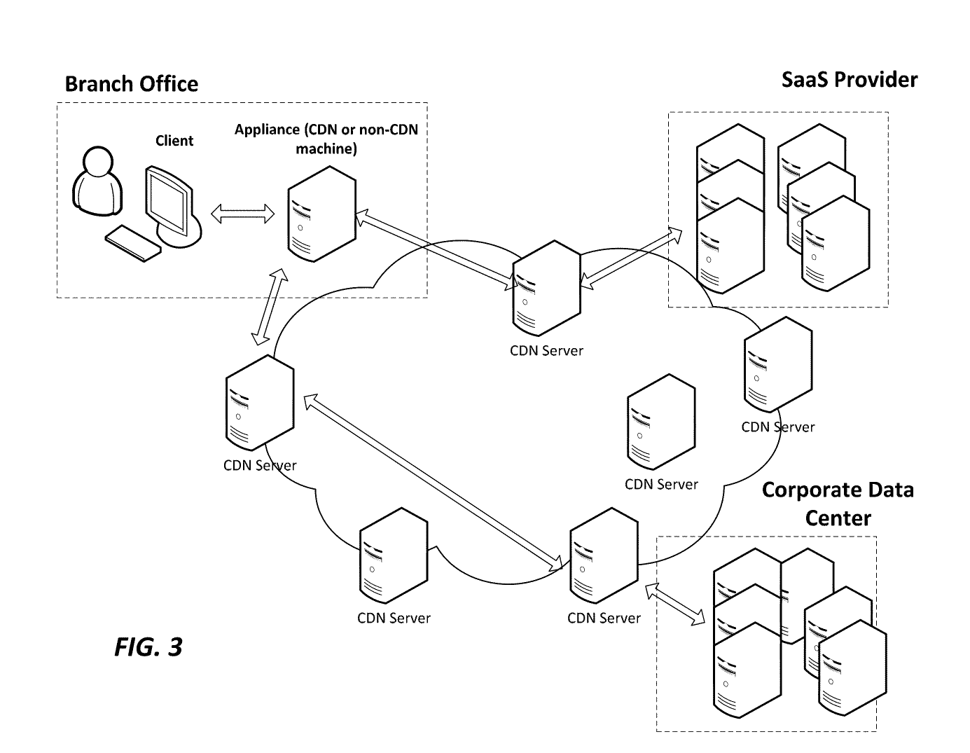

To accomplish these two use cases, CDN software may execute on machines (potentially in virtual machines running on customer hardware) hosted in one or more customer data centers, and on machines hosted in remote “branch offices.” The CDN software executing in the customer data center typically provides service configuration, service management, service reporting, remote management access, customer SSL certificate management, as well as other functions for configured web applications. The software executing in the branch offices provides last mile web acceleration for users located there. The CDN itself typically provides CDN hardware hosted in CDN data centers to provide a gateway between the nodes running behind the customer firewall and the CDN service provider's other infrastructure (e.g., network and operations facilities). This type of managed solution provides an enterprise with the opportunity to take advantage of CDN technologies with respect to their company's intranet, providing a wide-area-network optimization solution. This kind of solution extends acceleration for the enterprise to applications served anywhere on the Internet. By bridging an enterprise's CDN-based private overlay network with the existing CDN public internet overlay network, an end user at a remote branch office obtains an accelerated application end-to-end. FIG. 3 illustrates a general architecture for a WAN optimized, “behind-the-firewall” service offering such as that described above. Other information about a behind the firewall service offering can be found in teachings of U.S. Pat. No. 7,600,025, the teachings of which are hereby incorporated by reference.

### Computer Based Implementation

The subject matter described herein may be implemented with computer systems, as modified by the teachings hereof, with the processes and functional characteristics described herein realized in special-purpose hardware, general-purpose hardware configured by software stored therein for special purposes, or a combination thereof

Software may include one or several discrete programs. A given function may comprise part of any given module, process, execution thread, or other such programming construct. Generalizing, each function described above may be implemented as computer code, namely, as a set of computer instructions, executable in one or more microprocessors to provide a special purpose machine. The code may be executed using conventional apparatu—such as a microprocessor in a computer, digital data processing device, or other computing apparatus—as modified by the teachings hereof In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

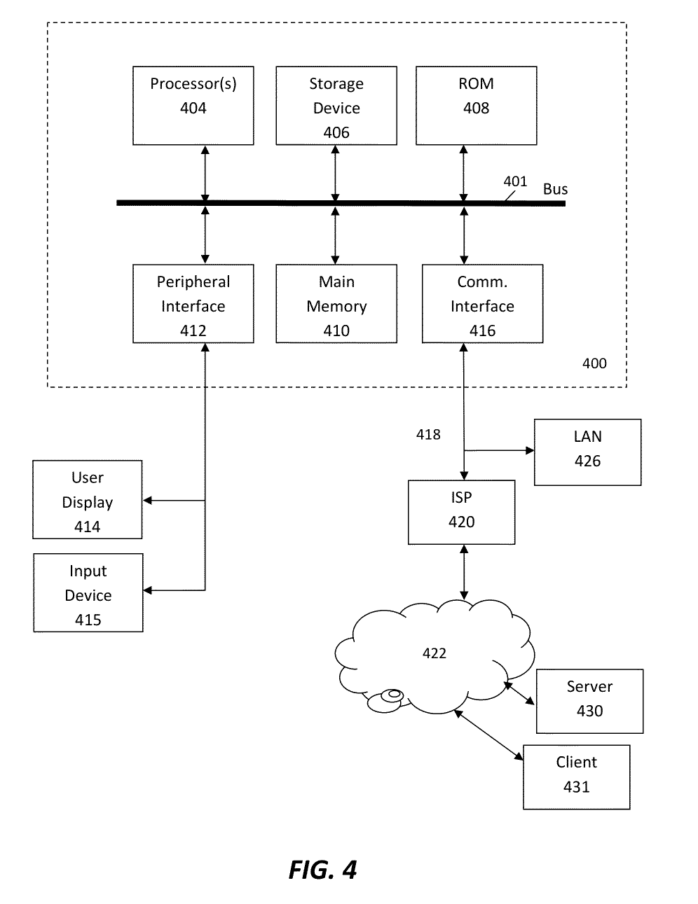

FIG. 4 is a block diagram that illustrates hardware in a computer system 400 on which embodiments of the invention may be implemented. The computer system 400 may be embodied in a client device, server, personal computer, workstation, tablet computer, wireless device, mobile device, network device, router, hub, gateway, or other device.

Computer system 400 includes a microprocessor 404 coupled to bus 401. In some systems, multiple microprocessor and/or microprocessor cores may be employed. Computer system 400 further includes a main memory 410, such as a random access memory (RAM) or other storage device, coupled to the bus 401 for storing information and instructions to be executed by microprocessor 404. A read only memory (ROM) 408 is coupled to the bus 401 for storing information and instructions for microprocessor 404. As another form of memory, a non-volatile storage device 406, such as a magnetic disk, solid state memory (e.g., flash memory), or optical disk, is provided and coupled to bus 401 for storing information and instructions. Other application-specific integrated circuits (ASICs), field programmable gate arrays (FPGAs) or circuitry may be included in the computer system 400 to perform functions described herein.

Although the computer system 400 is often managed remotely via a communication interface 416, for local administration purposes the system 400 may have a peripheral interface 412 communicatively couples computer system 400 to a user display 414 that displays the output of software executing on the computer system, and an input device 415 (e.g., a keyboard, mouse, trackpad, touchscreen) that communicates user input and instructions to the computer system 400. The peripheral interface 412 may include interface circuitry and logic for local buses such as Universal Serial Bus (USB) or other communication links.

Computer system 400 is coupled to a communication interface 416 that provides a link between the system bus 401 and an external communication link. The communication interface 416 provides a network link 418. The communication interface 416 may represent an Ethernet or other network interface card (NIC), a wireless interface, modem, an optical interface, or other kind of input/output interface.

Network link 418 provides data communication through one or more networks to other devices. Such devices include other computer systems that are part of a local area network (LAN) 426. Furthermore, the network link 418 provides a link, via an internet service provider (ISP) 420, to the Internet 422. In turn, the Internet 422 may provide a link to other computing systems such as a remote server 430 and/or a remote client 431. Network link 418 and such networks may transmit data using packet-switched, circuit-switched, or other data-transmission approaches.

In operation, the computer system 400 may implement the functionality described herein as a result of the microprocessor executing program code. Such code may be read from or stored on memory 410, ROM 408, or non-volatile storage device 406, which may be implemented in the form of disks, tapes, magnetic media, CD-ROMs, optical media, RAM, PROM, EPROM, and EEPROM. Any other non-transitory computer-readable medium may be employed. Executing code may also be read from network link 418 (e.g., following storage in an interface buffer, local memory, or other circuitry).

A client device may be a conventional desktop, laptop or other Internet-accessible machine running a web browser or other rendering engine, but as mentioned above a client may also be a mobile device. Any wireless client device may be utilized, e.g., a cellphone, pager, a personal digital assistant (PDA, e.g., with GPRS NIC), a mobile computer with a smartphone client, tablet or the like. Other mobile devices in which the technique may be practiced include any access protocol- enabled device (e.g., iOS™-based device, an Android™-based device, other mobile-OS based device, or the like) that is capable of sending and receiving data in a wireless manner using a wireless protocol. Typical wireless protocols include: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP. The WAP (wireless access protocol) also provides a set of network communication layers (e.g., WDP, WTLS, WTP) and corresponding functionality used with GSM and CDMA wireless networks, among others.

In a representative embodiment, a mobile device is a cellular telephone that operates over GPRS (General Packet Radio Service), which is a data technology for GSM networks. Generalizing, a mobile device as used herein is a 3G-(or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The techniques disclosed herein are not limited for use with a mobile device that uses a particular access protocol. The mobile device typically also has support for wireless local area network (WLAN) technologies, such as Wi-Fi. WLAN is based on IEEE 802.11 standards. The teachings disclosed herein are not limited to any particular mode or application layer for mobile device communications.

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that trademarks appearing herein are the property of their respective owners and used for identification and descriptive purposes only, given the nature of the subject matter at issue, and not to imply endorsement or affiliation in any way.

1. A computer-implemented method for enforcing web application workflow at a server, the web application workflow having a plurality of URLs which an end-user can traverse, the method comprising:
defining a set of relationships between URLs, the relationships comprising a destination URL and one or more permissible source URLs for that destination URL, where at least one relationship has a destination URL and a plurality of permitted source URLs;
storing said relationships in a data store accessible to the server;
at the server, upon receiving a request from the client that is directed to the destination URL, validating whether the client visited one of the plurality of permitted source URLs.

2. The method of claim 1, wherein if validation fails, taking an action against the client request, the action being any of denying the client request, serving an alternate page, alerting or logging the client request.

3. The method of claim 1, wherein if validation succeeds, then serving the content located at the destination URL.

4. The method of claim 1, wherein the validation comprises checking a URL referer field to see if it matches any one of the plurality of permitted source URLs.

5. The method of claim 1, wherein the validation comprises extracting a purported source URL from the request for the destination URL, determining that the purported source URL is authentic, and determining that the purported source URL is a permitted source URL for the requested destination URL.

5. The method of claim 1, wherein the validation comprises checking a time value to enforce a minimum time between the client visiting the destination URL and a source URL.

6. The method of claim 1, further comprising, upon receiving a request from the client directed to one of the plurality of permitted source URLs, storing a secure token on the client (e.g., in a cookie).
